(19) United States
(12) Patent Application Publication
(10) Pub. No.: US 2004/0207875 A1
(43) Pub. Date: Oct. 21, 2004

(54) Printing system

(75) Inventor: Masakatsu Endo, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/648,794

(22) Filed: Aug. 27, 2003

(30) Foreign Application Priority Data
Aug. 27, 2002 (JP) 2002-247037

(51) Int. Cl. G06K 15/02; H04N 1/387; H04N 1/393

(52) U.S. Cl. 358/1.18; 358/1.2; 348/207.2

(57) ABSTRACT

It is an object of the present invention, when extracting arbitrary region(s) from image(s) taken with a digital camera or the like and printing same, to make it possible to carry out borderless printing.

During cropped printing, because user(s) can specify arbitrary region(s) of arbitrary size(s), aspect ratio(s) of cropped image(s) and aspect ratio(s) of printing paper will not match, and distorted image(s) will result if an attempt is made to carry out printing with no border at any of the four edges thereof. Image(s) may therefore be rotated based on aspect ratio(s) of print region(s) defined by print layout(s) and aspect ratio(s) of cropped image(s) (S17 through S19), and image(s) may be enlarged and/or reduced such that aspect ratio(s) thereof is or are preserved unaltered so as to cause no margin to be formed on at least either the two horizontal or the two vertical edges of print region(s) (S20). Furthermore, when carrying out borderless printing, portion(s) extending beyond edge(s) of printing paper may be taken into consideration in advance in establishing image cutting frame(s). This will make it possible for printing of image(s) at locus or loci specified by user(s) to be carried out faithfully, without distortion, and without borders at two edges thereof.

### FIELD OF ART

The present invention pertains to a printing system capable of carrying out “borderless” printing of arbitrary portion(s) of image data created, for example, at digital camera(s) or other such image data creation apparatus(es).

### TECHNICAL BACKGROUND

When using a printer to print image data created, for example, with a digital camera, personal computer, or the like, it is ordinarily the case under normal circumstances for margins to be formed around images. But users who dislike seeing their images bordered and encroached upon by margins around same can use a printer capable of borderless printing to print images over the full expanse of the printing paper.

In carrying out borderless printing so that no margin is formed around an image, the image to be printed is enlarged or reduced to the extent necessary to make it slightly larger than the printing paper, printing being carried out such that the portion of the image beyond the printing paper is cut off.

Furthermore, printing of an arbitrary region cut out of an image, i.e., “cropped printing,” is also known. By, for example, moving a region frame displayed in superposed fashion over an image to an arbitrary location within the image and indicating the locus at which printing is to be carried out such that the region frame is enlarged or reduced, it is possible for a user to extract only the desired portion from the overall image and print same.

The aspect ratio (ratio between height and width) of an image displayed at the display of a digital camera or the like will typically differ from the aspect ratio of the printing paper. Under ordinary circumstances it is often the case that the aspect ratio of the displayed image is 3:2 while the aspect ratio of the printing paper is 4:3, but as there are various formats for printing paper it will not always be true that the aspect ratio thereof will be set to 4:3.

Thus, because the aspect ratio of the image to be printed differs from the aspect ratio of the printing paper, in the event that borderless printing is carried out the printed image might end up being distorted. Particularly in situations such as when carrying out printing where borderless printing is combined with cropped printing in which a desired region is extracted and printed, because there is no telling what the aspect ratio of the image specified as printing locus might be, it is highly likely that enlargement or reduction carried out in order to achieve borderless printing of the image in the specified region will cause the printed image to be different from the image intended by the user. More specifically, this could result in a situation where a portion of the image specified by the user is, for example, not printed, or the image might be printed in distorted fashion such that it is elongated vertically or horizontally. Where such distortion is conspicuous, because the print obtained by the user will be of an image which is different from the desired image, it will not be possible to satisfy the customer.

### DISCLOSURE OF INVENTION

The present invention was conceived in light of the foregoing problems, it being an object thereof to provide a printing system making it possible to carry out borderless printing of image(s) at locus or loci as desired by user(s) without impairing image appearance even when printing arbitrary region(s) within image(s) as specified by user(s).

In order to solve one or more of the foregoing problems, a printing system associated with the present invention may comprise image data creation apparatus(es) creating image data and printer(s) carrying out printing based on image data acquired from image data creation apparatus(es); and may furthermore comprise storage means, region specification means, image acquisition means, cutting means, image processing means, and printing means.

Storage means may store image data; it being possible, for example, to employ PC card(s), memory device(s), hard disk drive(s), and/or the like for same. Region specification means are for specifying arbitrary region(s) within image data at which cropped printing should take place. Image acquisition means may acquire image data stored at storage means. Cutting means may cut subset(s) from acquired image data using cutting frame(s) established based on region(s) specified by region specification means. Image processing means may, based on aspect ratio(s) of printing paper and aspect ratio(s) of image(s) in specified region(s), carry out prescribed processing on image(s) in specified region(s) so as to cause no margin to be formed at least either horizontally or vertically on printing paper. Printing means may print processed image(s).

Personal computer(s), digital camera(s), scanning equipment, mobile phone(s), portable information terminal(s), and the like may be cited as examples of “image data creation apparatus(es).” Laser printer(s), inkjet printer(s), and the like may be cited as examples of printer(s).

In achieving borderless printing such that no margin is formed at least either horizontally or vertically on printing paper, enlargement, reduction, rotation, and/or other such processing may be applied based on aspect ratio(s) of printing paper and aspect ratio(s) of image(s) in specified region(s) (hereinafter also referred to as “cropped image(s)”) so as to prevent aspect ratio(s) of image(s) from being substantially altered (preferably preserving aspect ratio(s)). That is, in the event that four-sided borderless printing—in which no margin is formed on any of the four edges of the printing paper—is carried out, distortion of cropped image(s) will be unavoidable so long as aspect ratio(s) of printing paper and aspect ratio(s) of cropped image(s) do not match. However, in the event that two-sided borderless printing—in which either no margin is formed horizontally on printing paper or no margin is formed vertically on printing paper—is carried out, it will be possible to carry out printing such that aspect ratio(s) of cropped image(s) is or are preserved.

It should be noted that, in accordance with the present invention, size(s) of cropping region(s) specified by user(s) and size(s) of image(s) cut by cutting means need not match. Cutting frame(s) may be established based on specified region(s) and image data subset(s) may be cut out therewith, and in accordance with the present invention there are situations in which, during borderless printing, portion(s) sacrificed because it or they extend beyond print locus or loci is or are taken into consideration when establishing cutting frame(s). That is, cutting means may be such that portion(s) extending beyond edge(s) of printing paper is or are also taken into consideration in establishing cutting frame(s) larger than locus or loci specified by region specification means, image data being cut therewith so as to cause no margin to be formed at least horizontally or vertically on printing paper. Note that, both in the case where image(s) are enlarged and in the case where image(s) are reduced, there will be situations in which the cutting frame(s) that are established are larger than region(s) specified by user(s). But where borderless printing is possible without causing portion(s) of image data to extend beyond edge(s) of printing paper during printing, the cutting frame(s) that are established will match region(s) specified by user(s).

With borderless printing, image(s) may be enlarged so as to be slightly larger than printing paper (print region(s)), elimination of margin(s) being accomplished by “sacrificing” portion(s) extending beyond printing paper; where image(s) in region(s) specified by user(s) are cut therefrom unaltered, printing will be such that small amount(s) of image(s) are lost, lost amount(s) corresponding to sacrificed portion(s). Here, sacrificed portion(s) beyond edge(s) of printing paper may be taken into consideration such that the cutting frame(s) that are established are larger than region(s) specified by user(s), making it possible to carry out borderless printing of image(s) at locus or loci as desired by user(s).

Furthermore, in accordance with the present invention, image data creation apparatus(es) may have storage means and region specification means; and printer(s) may have image acquisition means, cutting means, image processing means, and printing means; and image data stored in storage means on the one hand, and information pertaining to region(s) specified by region specification means on the other, may be sent from image data creation apparatus(es) to printer(s) as respectively different types of information.

That is, image data on the one hand, and information specifying locus or loci to be cut out of image data and printed (e.g., coordinate data for identifying region(s)) on the other, may be provided to printer(s), and the task of cutting image(s) out of image data at specified region(s) and printing same may be left to printer(s). It should be noted that this would be different from cutting desired locus or loci out of original image data and sending same to printer(s).

Here, image processing means may enlarge and/or reduce and/or rotate cropped image(s) based on aspect ratio(s) of printing paper and aspect ratio(s) of cropped image(s) and print layout(s). The reason for also taking print layout(s) into consideration is due to the fact that there are also situations in which a plurality of images might be assigned to a single page, for example, and printed. More specifically, this would be so in a situation where a plurality of images are assigned in the direction of the length of roll paper, and the respective images are enlarged, reduced, and/or rotated so as to cause no margin to be formed in the width direction of the roll paper. Note also that when printing on roll paper it is possible, by cutting the roll paper so as to cause no margin to be formed in the direction of the length of the roll paper, to cause the final print(s) which are obtained to be four-sided borderless print(s).

In the event that cropped image(s) are rotated, image processing means may carry out rotation such that orientation(s) of edge(s) in long direction(s) of cropped image(s) match orientation(s) of edge(s) in long direction(s) of print region(s) established at printing paper. Where a single image is printed on a single page, the print region and the printing paper more or less match. Where a plurality of images are assigned to a single page which is printed, a plurality of print regions (also called print frames) may be established based on print layout(s).

Image processing means may enlarge and/or reduce cropped image(s) such that aspect ratio(s) thereof are preserved, and/or may enlarge and/or reduce cropped image(s) so as to be within allowed range(s) in the event that it is determined that it is possible to achieve borderless printing with no margin on any of the four edges and with distortion within preestablished allowed range(s).

For example, in the event that enlargement and/or reduction of cropped image(s) with preservation of aspect ratio(s) would leave small margin(s) horizontally or vertically on printing paper, four-sided borderless printing might be carried out with occurrence of distortion and without preservation of aspect ratio(s) of cropped image(s). Here, preestablishment of allowed range(s), e.g., allowing distortion so long as it is within a few percent or the like, makes it possible to increase the number of circumstances under which it is possible to carry out four-sided borderless printing without impairment to appearance, improving usefulness.

A printing system associated with the present invention may furthermore comprise report means for reporting to user(s) that margin(s) may be produced horizontally and/or vertically on printing paper.

When user(s) issue instruction(s) to carry out borderless printing of cropped image(s), by reporting in advance that there is no guarantee that four-sided borderless printing will be possible but that instead only either horizontal or vertical two-sided borderless printing could result it is possible to improve user-friendliness. Such reporting might, for example, be accomplished through display of print preview screen(s) and/or through display of icon(s) representing two-sided borderless printing. Alternatively or in addition thereto, such reporting might be accomplished by means of text or audible message(s) or the like.

The present invention may also take the form of an image data creation apparatus and/or a printer.

### BRIEF DESCRIPTION OF DRAWINGS

FIG. 1 is a block diagram showing a schematic overview of a printing system associated with a first embodiment of the present invention.

FIG. 2 contains diagrams illustrating (a) a cropped printing specification method, and (b) the simplified structure of a DPOF script file.

FIG. 3 contains explanatory diagrams showing a situation that might exist when an image which has been cropped so as to be long vertically is printed on short-edge-fed printing paper.

FIG. 4 contains explanatory diagrams showing a situation that might exist when an image which has been cropped so as to be long vertically is printed on long-edge-fed printing paper.

FIG. 5 contains explanatory diagrams showing a situation that might exist when an image which has been cropped so as to be long vertically is printed in two vertically stacked fields on short-edge-fed printing paper.

FIG. 6 is a flowchart showing, in simplified fashion, print specification processing taking place at a camera.

FIG. 7 is a flowchart showing, in simplified fashion, print processing taking place at a printer.

FIG. 8 is a flowchart showing processing in which an image is cut, based on a region specified by a user, from an original image captured by a camera.

FIG. 9 is a flowchart showing, in simplified fashion, print specification processing taking place at a camera, this being associated with a second embodiment of the present invention.

FIG. 10 is a flowchart showing, in simplified fashion, print processing taking place at a printer.

FIG. 11 is a flowchart showing, in simplified fashion, print specification processing taking place at a camera, this being associated with a third embodiment of the present invention.

### BEST MODE FOR CARRYING OUT INVENTION

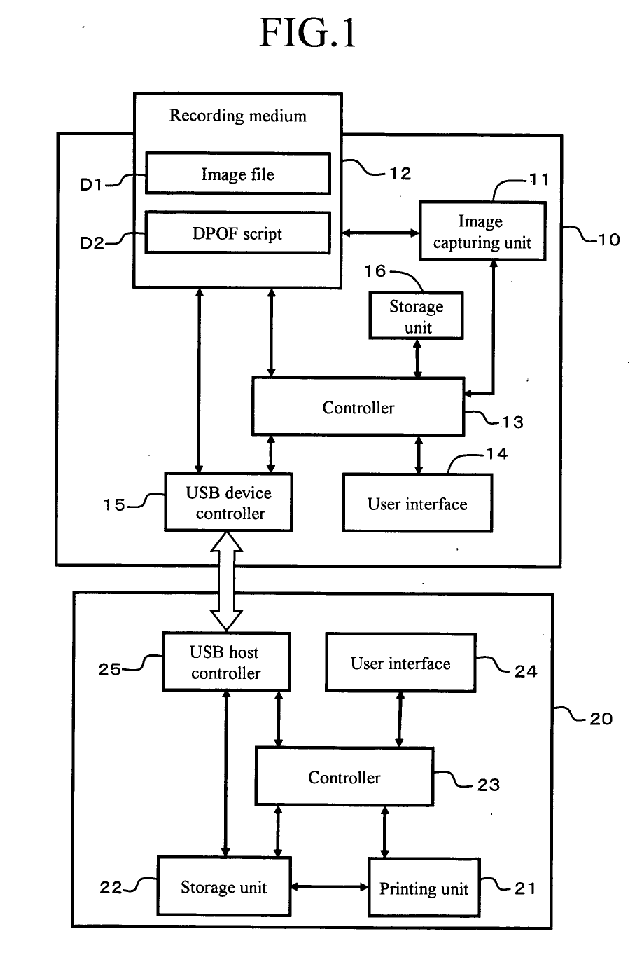

Below, referring to FIGS. 1 through 11, embodiments of the present invention are described in detail.

1. First Embodiment

First, referring to FIGS. 1 through 8, a first embodiment of the present invention will be described. FIG. 1 is a block diagram showing a schematic overview of a printing system associated with the present embodiment.

Digital camera (hereinafter abbreviated as “camera”) 10 is capable of capturing images and storing same as electronic data, and is capable of sending stored image data directly to printer 20 with no personal computer(s) intervening therebetween and causing printing to be carried out. Camera 10 supports the DPOF (Digital Print Order Format) specification. DPOF defines a specification whereby information identifying images selected by a user, the number of sheets or copies to be printed, the manner in which printing is to be carried out, and other such print specification information is saved in a text-based file (DPOF script file); sending of such print specification information to a printer at a lab or to a printer owned by the user which supports DPOF making it possible to carry out automatic printing with no personal computer intervening therebetween.

Camera 10 comprises image capturing unit 11, recording medium 12, controller 13, user interface 14, USB device controller 15, and storage unit 16. Image capturing unit 11—comprising, for example, CCD (charge-coupled device) elements, lenses, preprocessing circuitry, and so forth—converts images of photographic subjects into electronic form and outputs same.

Recording medium 12—being, for example, PC card, memory, or other such rewritable recording media—is removably installed at a card slot of camera 10. Recorded on recording medium 12 are file(s) D1 containing image(s) captured by user(s), and DPOF script file(s) D2 for making specifications with regard to printing.

A microcomputer system comprising CPU(s), RAM, ROM, and so forth constitutes controller 13, which executes various programs. User interface 14—comprising, for example, liquid crystal display(s), operating switch(es), and/or the like—displays captured images and/or operation menu(s), and moreover, accepts instructions and the like from user(s). USB device controller 15 is for carrying out transfer of data with printer 20 by way of USB cable(s).

Thus, camera 10 might be connected to printer 20 by way of a USB cable, sending of image file(s) D1 and DPOF script file(s) D2 from camera 10 to printer 20 making it possible to carry out printing.

More specifically, recording medium 12 of camera 10 might, for example, function as a storage-class USB device, access to stored content being permitted by means of USB host controller 25 of printer 20, described below. Three types of logical channel—control pipe, bulk pipe, and interrupt pipe—might be set up between USB device controller 15 of camera 10 and USB host controller 25 of printer 20, image file(s) being sent to printer 20 by way of bulk pipe(s). Moreover, control pipe(s) might be used for transmission of various control commands; interrupt pipe(s) might be used for transmission of request inquiry commands (Interrupt In) from printer 20 to camera 10. By utilizing this configuration, print request(s) can be sent from camera 10 to printer 20. Request inquiry commands might, for example, be repeatedly sent from printer 20 to camera 10 with relatively short periodicity therebetween, and camera 10 might return a print request to printer 20 as its response to such a request inquiry command. Or the constitution might be such that the print request is stored at a prescribed location at recording medium 12, with printer 20 periodically accessing the prescribed storage location and carrying out determination as to whether a print request is present.

Constitution of printer 20 will now be described. Printer 20 comprises printing unit 21, storage unit 22, controller 23, user interface 24, and USB host controller 25, and is configured as a serial color printer with DPOF support.

Printing unit 21 is constituted so as to include print engine(s) and engine controller(s). Printing unit 21 might, for example, create image data for printing in units of bands, prescribed printing being carried out in accordance with specified settings as a result of causing printhead(s) to scan in a paper feed direction and in a direction orthogonal thereto. Controller 23—comprising, for example, hard disk drive(s) and/or semiconductor memory device(s)—stores image file(s) and the like acquired from camera 10. User interface 24—comprising, for example, liquid crystal panel(s), operating switch(es), and/or the like—accepts instructions and the like from user(s), and also displays progress of printing and so forth. USB host controller 25 is for carrying out data communication with camera 10 via USB. Printer 20 is capable of acquiring data and/or command(s) as a result of accessing, primarily, storage unit 16 and/or recording medium 12 of camera 10.

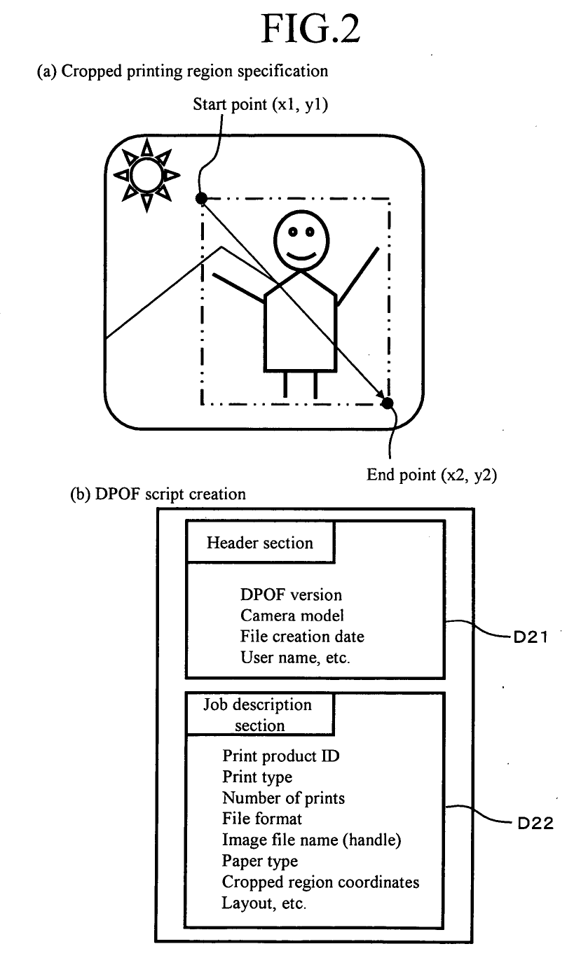

Camera 10 is capable of requesting that printer 20 carry out, for example, standard printing, index printing, cropped printing, borderless printing, and various other types of printing. In this regard, referring to FIG. 2, a cropped printing specification method and creation of a DPOF script file will be described. Cropped printing is the extraction and printing of arbitrary location(s) within image(s) as specified by user(s). Furthermore, borderless printing is printing which either causes no margin to be formed horizontally on printing paper or which causes no margin to be formed vertically thereon, or which causes no margin to be formed on any of the four edges thereof. It is characteristic of the invention that, during cropped printing for which arbitrary region(s) within image(s) can be specified by user(s), borderless printing is carried out just as intended by user(s) without causing distortion of image(s) (or without causing much distortion of image(s)). Hereinafter, borderless printing of cropped image(s) may also be referred to as borderless cropped printing.

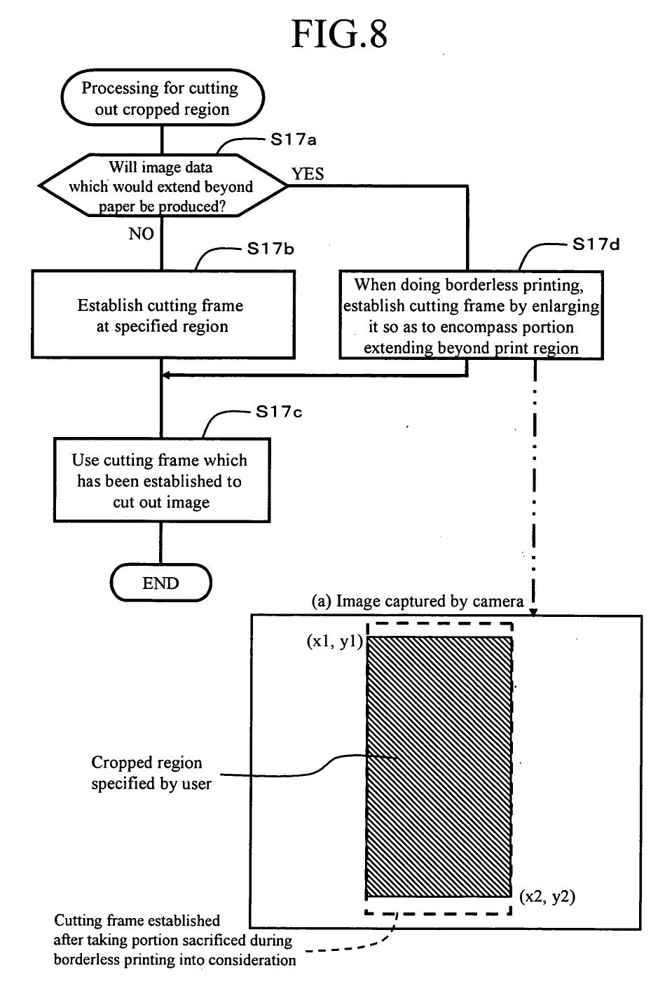

FIG. 2(a) is emblematic of a screen that might be displayed at user interface 14 of camera 10, in which case a user wishing to carry out cropped printing might select an image file to be printed from among a group of image files stored at recording medium 12, and might specify by means of region specification frame F a locus within this retrieved image that the user wishes to extract and print. By carrying out operation(s) in which any of the several sides and/or corners of specification frame F is or are grabbed using pointer(s), user(s) can freely change the size and/or position of specification frame F. Note also, as indicated at FIG. 8 and as described below, that cropping region(s) specified by user(s) need not necessarily match cut region(s) at printer(s); during borderless printing, portion(s) sacrificed due to the fact that the data thereat extends beyond printing paper may be taken into consideration such that cutting frame(s) established at printer 20 is or are larger in size.

After the user has, by way of user interface 14 of camera 10, specified image file(s) desired to be printed, locus or loci for cropped printing, number of copies, and so forth, DPOF script file(s) is or are created as shown at FIG. 2(b).

A DPOF script file might, for example, be written in text code and might be divided into header section(s) D21 and job description section(s) D22. Header section D21 contains applicable DPOF version number(s), model name(s) of camera(s) 10, DPOF script file creation date(s), and also user information such as user name(s) and/or user address(es) and telephone number(s). Job description section D22 contains print product ID(s), print type(s) (standard printing, index printing, etc.), number(s) of prints, file format(s), image file path information, coordinate data specifying region(s) at which cropping is to take place, print layout(s), and so forth. Note that each of the foregoing items may in some cases be required and in some cases be optional.

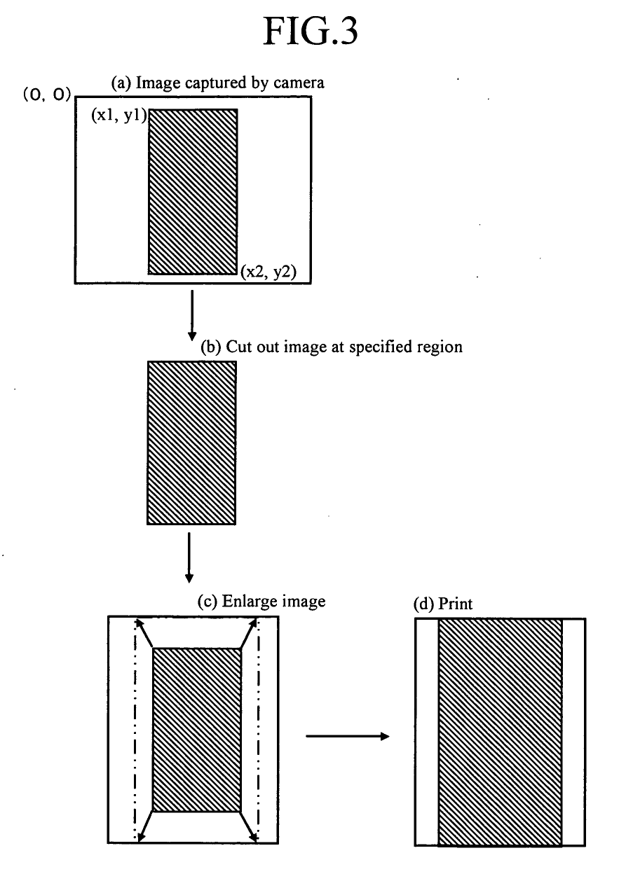

Next, referring to FIGS. 3 through 5, an overview of borderless cropped printing in accordance with the present embodiment will be described by means of several examples. Note at FIGS. 3 through 5 that while the general fact of enlargement, reduction, and rotation as might be performed for carrying out borderless printing of cropped images is indicated, no attempt has been made to show the relationship between cropped region(s) as specified versus actual cutting frame(s).

FIG. 3 shows a situation that might exist when only one copy of an image which has been cut from an original image so as to be long vertically is printed on short-edge-fed printing paper. Controller 23 of printer 20 cuts the image data subset selected as the cropped region (FIG. 3(b)) out of the image file specified in the DPOF script file (FIG. 3(a)). The image cut therefrom is then enlarged while aspect ratio is maintained until a size is reached such that no margin is formed at either the top or the bottom of the printing paper (FIG. 3(c)). As a result, it is possible to achieve two-sided borderless printing such that there is no margin at either the top or the bottom, margins being formed at only the left and the right sides (FIG. 3(d)). While the detailed layout including the manner in which images are arranged are set at printer 20, in the situation shown in FIG. 3 images are typically arranged centrally along the horizontal direction of the printing paper so as to produce margins of roughly equal size at the left and the right sides thereof

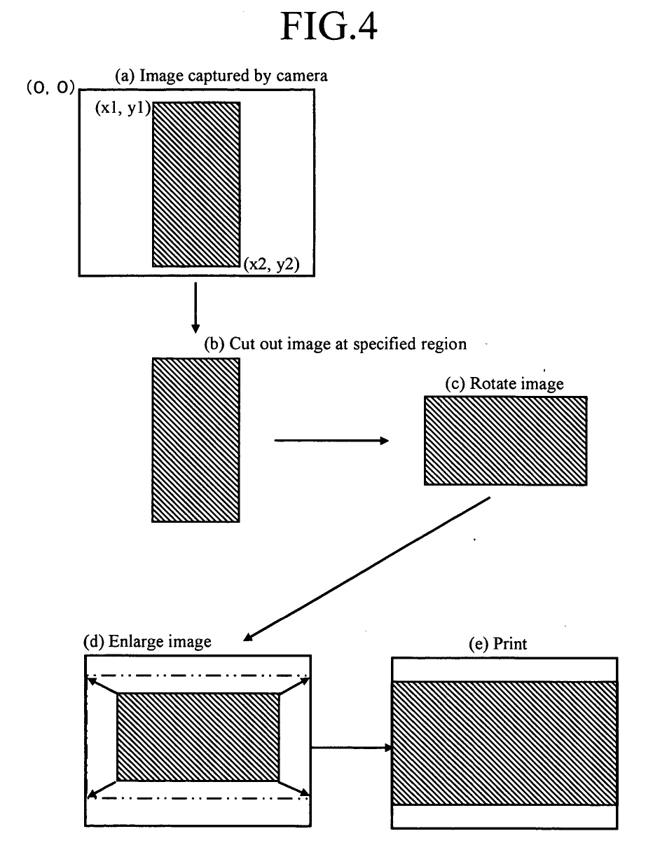

FIG. 3 shows a situation that might exist when only one copy of an image which has been cut from an original image so as to be long vertically is printed on long-edge-fed printing paper. That is, in the situation shown, the orientation of the image and the orientation of the printing paper do not match, and after cutting an image from the original image at the specified region (FIG. 4(b)), the image is rotated 90 degrees so as to cause the long direction of the image to match the long direction of the printing paper (FIG. 4(c)). Furthermore, the image is enlarged while aspect ratio is preserved until a size is reached such that no margin is formed at either the left or the right side of the printing paper (FIG. 4(d)). As a result, it is possible to achieve two-sided borderless printing such that margins are present at only the top and the bottom of long-edge-fed printing paper (FIG. 4(e)). Note that whereas in the example shown in FIGS. 3 and 4 the image which is cut is smaller in size than the printing paper, in the reverse situation in which the cut image is larger than the printing paper the image should be reduced instead so as to prevent formation of borders at the prescribed two edges.

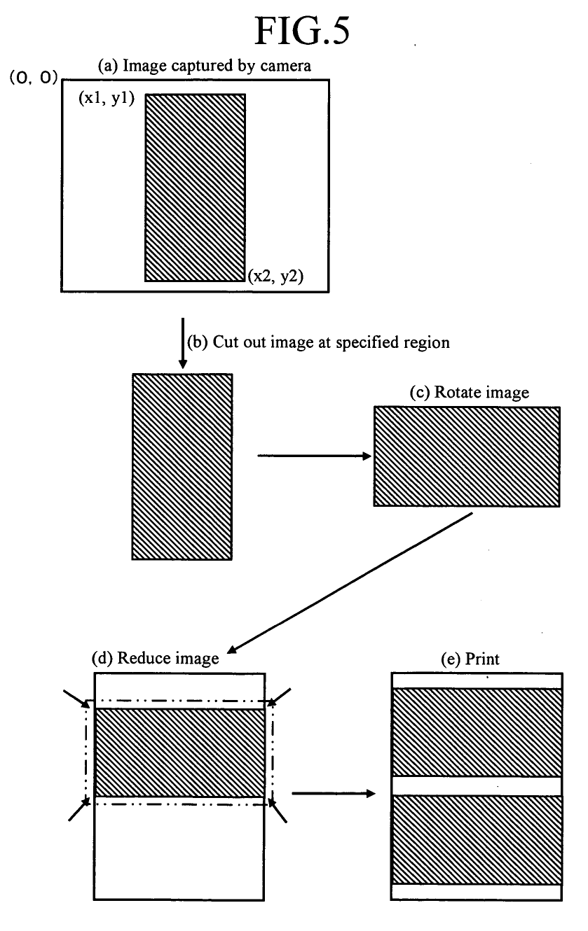

FIG. 5 shows a situation that might exist when an image which has been cut from an original image so as to be long vertically is printed in two vertically stacked fields on short-edge-fed printing paper. How the two images are printed one after another in vertically stacked fashion, the locations set for the regions at which each image is printed, the sizes thereof, and other such aspects of the layout are left to printer 20. Here, the respective images are arranged such that they are oriented horizontally in two vertically stacked fields for borderless cropped printing.

First, the image is cut out at the specified region (FIG. 5(b)), and the image is rotated 90 degrees (FIG. 5(c)). Based on the foregoing vertically stacked two-field layout, print regions for printing the images so as to cause their long directions to be horizontal are logically established on the printing paper. The image is then rotated so that the long direction of the image which was cut out of the original image will match the long directions of the printing regions. Next, leaving aspect ratio unaltered, the image is reduced so as to cause the image to fit within the foregoing print region (FIG. 5(d)). Note that were the image, after being rotated so as to be horizontal, smaller than the print region, the image would be enlarged such that the aspect ratio thereof is preserved unaltered.

In this way, after image size has been adjusted, the two images are printed on printing paper in vertically stacked fashion (FIG. 5(e)). Each image is respectively printed in two-sided borderless fashion. Where roll paper is employed as printing paper, making a series of cuts at intervals along the vertical direction of the paper (direction of transport of roll paper) makes it possible to eliminate borders on all four sides. Note that while situations such as that in which image(s) cut from original image(s) so as to be long horizontally is or are printed on short-edge-fed printing paper are also possible, as these can be readily understood from the foregoing description, description of same is omitted here.

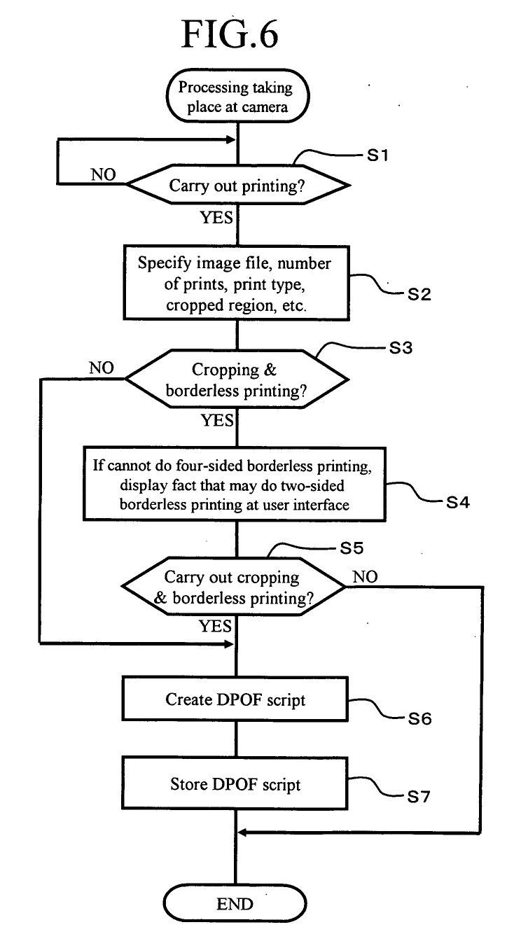

Next, referring to FIGS. 6 through 8, an overview of operations taking place in printing system(s) for achieving borderless cropped printing will be described. Hereinafter, “step” is abbreviated “S”. Note that flowcharts shown in the drawings indicate operations in schematic fashion, and may differ from actual programming.

First, FIG. 6 shows print specification processing which might be executed at camera 10. By way of user interface 14, user(s) enter image file(s) desired to be printed, number of copies/sheets of selected image(s) to be printed, print type(s), region(s) at which cropping is to take place, and various other information necessary for printing (S1, S2).

Next, controller 13 of camera 10 determines whether the user wishes to carry out borderless cropped printing (S3). In the event that the user has requested borderless cropped printing, the fact that two-sided borderless printing may instead be carried out is reported to the user by way of user interface 14 (S4). Furthermore, the user's preference with respect to whether it is alright to carry out two-sided borderless cropped printing is ascertained (S5), and DPOF script file(s) for carrying out two-sided borderless cropped printing is or are created (S6). Created DPOF script file(s) is or are stored at prescribed storage region(s) (S7), and is or are sent to printer 20 in response to inquiry or inquiries or the like from printer 20.

Moreover, at a point in time when a user simultaneously selects both cropped printing and borderless printing, the fact that it could be that four-sided borderless printing will not be possible but that instead only two-sided borderless printing could result might be displayed at a display or the like. Alternatively, such fact might have been stated in advance in the product catalog and/or operation manual, with reporting of same to the user by way of user 14 being omitted.

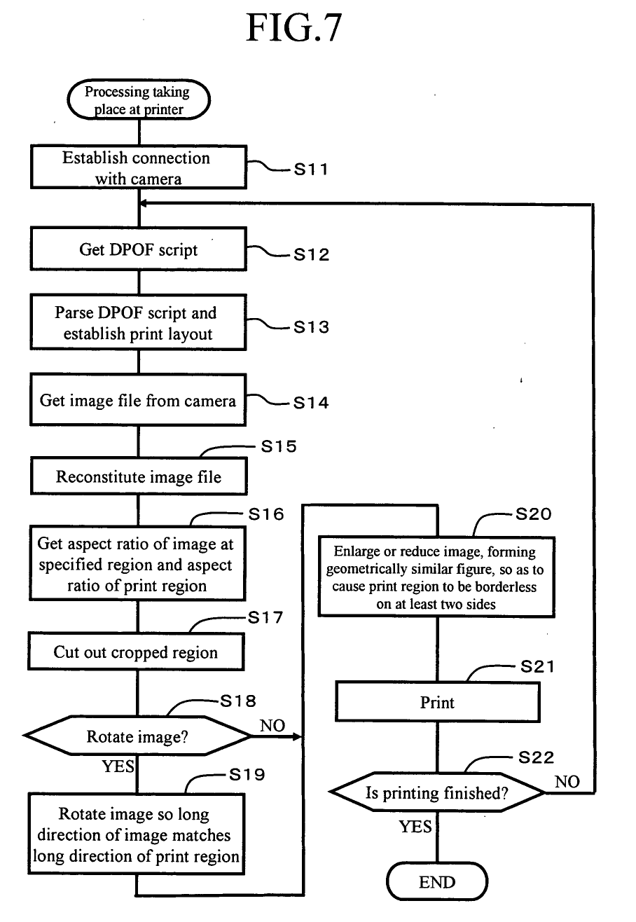

Next, FIG. 7 shows print processing which might be executed at printer 20. When camera 10 and printer 20 are connected by means of USB cable(s) with the power turned ON at each, communication connection(s) is or are established between camera 10 and printer 20 (S11). Furthermore, printer 20 obtains, from USB device controller 15 of camera 10, “device descriptor(s)” describing the USB device structure thereof.

Next, printer 20 obtains, in the form of response(s) to request inquiry command(s) and/or by examining prescribed region(s) at recording medium 12, DPOF script file(s), describing print request(s), from camera 10 (S12).

Furthermore, the DPOF script file(s) is or are parsed, print layout(s) is or are set (S13), and the image file(s) for which printing was specified is or are obtained from recording medium 12 of camera 10 (S14). Printer 20 reconstitutes the image file(s), which might have been compressed in accordance with, for example, JPEG or other such format (S15), obtains cropped image aspect ratio(s) resulting from region specification and aspect ratio(s) of print region(s) established on printing paper (S16), and cuts image data out of reconstituted original image(s) at locus or loci specified as cropped region(s) (S117). The manner in which image data is cut out therefrom will be described in further detail together with FIG. 8.

Next, based on aspect ratio(s) of cropped image(s) cut out therefrom and aspect ratio(s) of print region(s) established on printing paper, determination is made as to whether cropped image(s) should be rotated (S18).

As described above, in the event that long direction(s) of cropped image(s) and long direction(s) of print region(s) defined pursuant to print layout(s) do not match (e.g., where image(s) cropped so as to be long vertically is or are to be printed on long-edge-fed printing paper, where image(s) cropped so as to be long horizontally is or are to be printed on short-edge-fed printing paper, etc.), cropped image(s) is or are rotated so as to cause orientation(s) of edge(s) in long direction(s) of cropped image(s) to match orientation(s) of edge(s) in long direction(s) of print region(s) (S119). On the other hand, in the event that orientation(s) of edge(s) in long direction(s) of cropped region(s) match orientation(s) of edge(s) in long direction(s) of print region(s), S19 is skipped.

Next, image(s) is or are enlarged and/or reduced, forming geometrically similar figure(s), so as to cause print region(s) to be borderless on at least two sides thereof (S20). In this regard, while, as has been described above, print region(s) may vary depending on print layout(s), print region(s) is or are established such that no margin is formed at least either horizontally or vertically on printing paper. Accordingly, at S20, cropped image(s) is or are enlarged and/or reduced to match size(s) of print region(s) previously established on printing paper so as to be borderless on at least two sides thereof. Furthermore, cropped image(s), having been adjusted in such fashion, is or are printed at prescribed location(s) on printing paper (S21). The foregoing processing steps are repeated until all print jobs requested by camera 10 are processed (S22). Note that in situations such as those in which aspect ratio(s) of cropped image(s) specified by user(s) coincidentally match aspect ratio(s) of printing paper, four-sided borderless printing may be carried out.

Next, FIG. 8 is a flowchart showing processing carried out at S17 in FIG. 7, in which image(s) is or are cut.

First, at the outset, when carrying out borderless printing of image(s) cropped in accordance with region(s) specified at camera 10, determination is made as to whether image data subset(s) which would extend beyond printing paper edge(s) and which would be sacrificed will be produced (S17a). In the event that no data will be produced corresponding to portion(s) which would be located beyond printing paper edge(s) and which would be sacrificed, cutting frame(s) matching region(s) specified at camera 10 is or are established (S17b), and image(s) is or are cut out of original image data therewith (S17c). Conversely, in the event that it is determined that, as a result of carrying out borderless printing, perimeter(s) of image(s) for which region specification has been carried out would be located beyond printing paper edge(s) and would be lost (S17a: YES), cutting frame(s) is or are established such that it or they is or are enlarged in advance to encompass portion(s) extending beyond edge(s) of printing paper (S17d).

Here, as has been described above, when borderless printing is being carried out, there are situations in which image data is created so as to extend beyond printing paper edge(s), image data extending therebeyond being sacrificed so as to avoid formation of margin(s) on printing paper; and there are also situations in which borderless printing can be carried out without causing image data subset(s) to extend therebeyond. For example, there are cases such as those in which paper width (or height) more or less matches image data width (or height). Accordingly, it might be possible to carry out borderless printing in a situation where a cutting frame is established such that its size matches that of a cropped region specified by a user.

As shown beneath S17d, in an image (original image) captured by camera 10, a region specified by a user is indicated at the diagonally hatched portion thereof. Information signifying this region specified by the user is sent, separately from image data, to printer 20 in the form of coordinate data ((x1, y1), (x2, y2)) for two points at opposite corners of the region. As indicated by the dashed line in the drawing, printer 20 cuts image data therefrom after establishing a cutting frame larger by a prescribed amount than the user-specified region defined by the coordinate data. Here, the prescribed amount is based on the amount of image data which is to be located beyond printing paper edge(s) and which is to be discarded so as to permit borderless printing.

In accordance with the present embodiment as constituted in such fashion, it will be possible to achieve printing that is borderless at least either horizontally or vertically on printing paper even in the context of cropped printing in which user(s) is or are permitted to specify region(s) of arbitrary aspect ratio(s). Accordingly, appearance is improved relative to ordinary printing in which margin(s) remain around image(s), and increased user satisfaction is achieved.

Furthermore, because, in the event that the user specifies cropped image(s) in combination with borderless printing, the fact that two-sided borderless printing might be carried out is reported to the user beforehand by way of user interface 14 of camera 10, it is possible to preemptively avoid generation of print(s) which is or are radically different from the intent of the user, improving user-friendliness.

In addition, because sacrificed portion(s) located beyond edge(s) of printing paper are taken into consideration in advance during borderless printing such that the actual cutting frame(s) which are established are larger than region(s) specified by user(s), it is possible to carry out borderless printing of image(s) at locus or loci as desired by user(s) without loss of even small amount(s) thereof

2. Second Embodiment

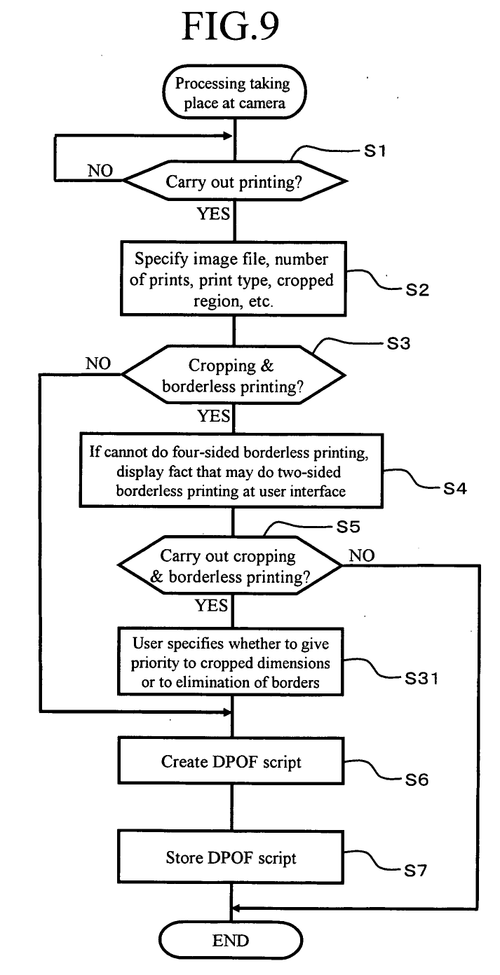

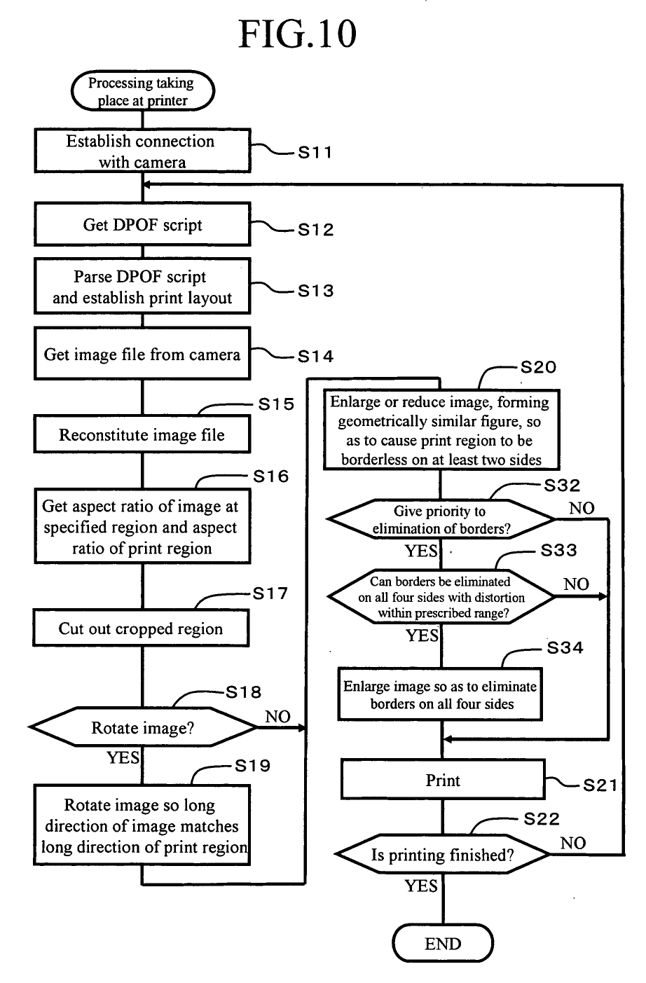

Next, referring to FIGS. 9 and 10, a second embodiment of the present invention will be described. Characteristic of the present embodiment is the fact that user(s) is or are made to specify in advance whether priority should be given to lack of formation of borders or whether priority should be given to faithful printing of cropped image(s); and in the event that priority should be given to borderless printing, four-sided borderless printing may be carried out such that cropped image(s) is or are distorted within prescribed range(s).

FIG. 9 shows print specification processing which might be executed at a camera, the user's preference with respect to whether it is alright to carry out borderless cropped printing being ascertained (S5), following which ascertainment is sought from the user regarding, and the user is made to specify, whether priority should be given to borderless printing or to cropped printing (S31). In other words, in the event that four-sided borderless printing of cropped image(s) can be carried out by causing some amount of distortion thereto, ascertainment is sought from the user with regard to whether distortion of cropped image(s) would be permissible.

On the other hand, FIG. 10 shows print processing which might take place at a printer; and in accordance with this processing, cropped image(s) is or are enlarged and/or reduced such that aspect ratio(s) thereof is or are preserved unaltered (S20), following which determination is made as to whether borderless printing priority mode is applicable (S32). In the event that it has been specified that priority should be given to borderless printing, determination is made as to whether four-sided borderless printing can be carried out if distortion of cropped image(s) is allowed to occur within prescribed range(s) (S33). Here, amounts(s) of change in cropped image aspect ratio(s), amount(s) of change in vertical size(s) and horizontal size(s), and the like, may be cited as examples of prescribed range(s) of distortion. Printing might be carried out in four-sided borderless fashion where the overall appearance of the image would not suffer were, say, several pixels' worth and/or several lines' worth of image data to be horizontally and/or vertically added to and/or subtracted from cropped image(s) (S34).

The present embodiment makes it possible to increase the number of situations in which four-sided borderless printing will be possible, increasing the usefulness thereof still further.

3. Third Embodiment

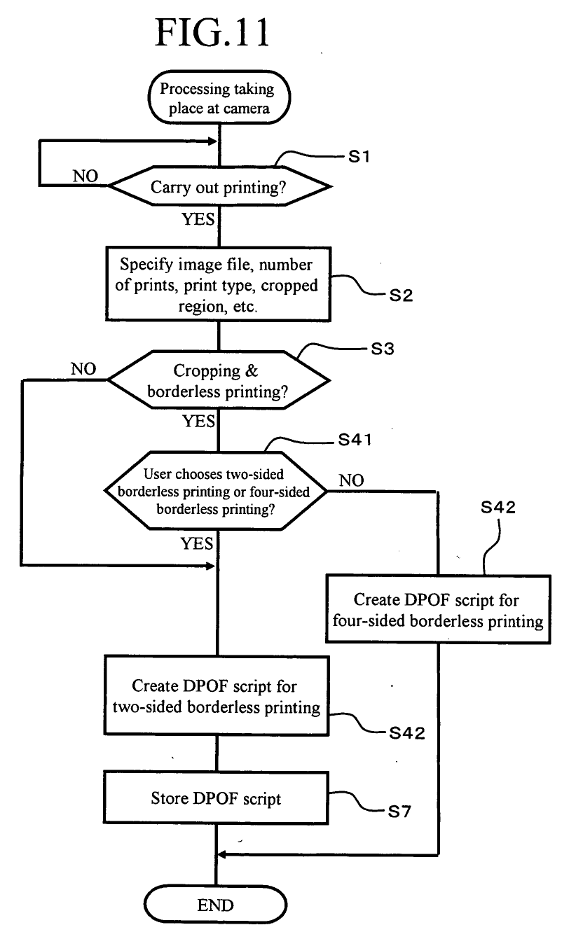

FIG. 11 shows print specification processing which might take place at a camera in accordance with a third embodiment. Characteristic of the present embodiment is the fact that, in the event that borderless cropped printing is specified, user(s) is or are made to choose in advance whether four-sided borderless printing should be carried out even if it means that cropped image(s) will be distorted, or whether two-sided borderless printing should be carried out with cropped image(s) being faithfully reproduced.

Upon cropped printing and borderless printing being both simultaneously specified by user(s) by way of user interface 14 (S3), the user is made to choose whether two-sided borderless printing should be carried out or whether four-sided borderless printing should be carried (S41).

In the event that the user chooses to carry out two-sided borderless printing, print request(s) for causing two-sided borderless printing of cropped image(s) while preserving aspect ratio(s) thereof such that it or they are unaltered is or are written to DPOF script file(s), as was the case in the foregoing embodiment(s) (S42).

Of the other hand, in the event that the user chooses to carry out four-sided borderless printing, print request(s) for causing four-sided borderless printing of cropped image(s) even if it means sacrificing aspect ratio(s) thereof is or are written to DPOF script file(s) (S42).

Because the present embodiment makes it possible for the user to choose, in accordance with the user's preference, between carrying out two-sided borderless printing with preservation of cropped image aspect ratio(s) and carrying out four-sided borderless printing with no guarantee that cropped image(s) will be faithfully reproduced, ease of use is improved.

4. Fourth Embodiment

The present invention may also be applied to printing systems in which roll paper is employed. By carrying out printing such that one of either the horizontal or vertical direction of cropped image(s) is made to more or less match the roll paper width dimension, and by, after printing has been carried out on the roll paper, making a series of cuts therein at intervals along the other direction of the cropped image(s), it is possible to cause the print(s) which are obtained to be four-sided borderless print(s).

In order to preserve aspect ratio(s) of cropped image(s), it is preferred that either the horizontal or vertical directions of cropped image(s) be made to match the roll paper width dimension. Here, the vertical dimension of a cropped image is taken to be Hc, the horizontal dimension of a cropped image is taken to be Wc, and the width dimension of the roll paper is taken to be Wr. Now, in the event that the cropped image is an image which is long vertically (Hc>Wc), the cropped image is rotated by 90 degrees or 270 degrees so as to lay it on its side. Next, enlargement or reduction processing is carried out so as to cause the cropped image vertical dimension Hc to match the roll paper width dimension Wr. As a result, one direction (Hc) of the cropped image is made to match the width of the roll paper, eliminating the margin(s) that would otherwise be produced in the width direction of the roll paper. Following conclusion of printing on roll paper, by either automatically or manually making cuts at interval(s) along the other direction (Wc) of the cropped image, it is possible to obtain a print without margins on any of the four sides thereof.

Where borderless printing is to be carried out on roll paper, it is preferred that specification of borderless printing mode be made possible by way of user interface(s) of host apparatus(es) (digital camera or the like) and/or printer(s).

Furthermore, where a plurality of images are to be continuously printed in borderless fashion on roll paper, respective images may be arranged so as to be adjacent with substantially no gap therebetween. In such case, lines indicating locations at which cutting should be performed may be printed in region(s) between adjacent images, on the printed surface and/or on the back surface of the roll paper.

Moreover, the foregoing embodiments of the present invention have been presented as examples for purposes of describing the present invention and without intent to limit the scope of the present invention to those embodiments alone. One of ordinary skill in the art will be able to carry out the present invention in the context of a wide variety of other embodiments without departing from the essence of the present invention.

Furthermore, the present invention is not limited to DPOF-type automatic printing systems but may also be applied to other types of printing systems.

Moreover, camera 10 and printer 20 need not be connected by way of USB, it being possible to carry out data communication by way of, for example, IEEE 1394 interface(s), wireless LAN, infrared, and/or the like.

1. In the context of a printing system comprising one or more image data creation apparatuses creating image data and one or more printers carrying out printing based on at least a portion of the image data acquired from at least one of the image data creation apparatus or apparatuses, a printing system characterized in that it comprises:
one or more storage means for storing at least a portion of the image data;
one or more region specification means for specifying one or more arbitrary regions within at least a portion of the image data at which cropped printing should take place;
one or more image acquisition means for acquiring at least a portion of the image data stored at at least one of the storage means;
one or more cutting means for cutting one or more subsets from at least a portion of the acquired image data using one or more cutting frames established based on at least a portion of at least one of the region or regions specified by at least one of the region specification means;
one or more image processing means for, based on one or more aspect ratios of one or more sheets of printing paper and one or more aspect ratios of one or more images in at least one of the specified region or regions, carrying out prescribed processing on at least a portion of at least one of the image or images in at least one of the specified region or regions so as to cause no margin to be formed at least either horizontally or vertically on at least one of the sheet or sheets of printing paper; and
one or more printing means for printing at least a portion of at least one of the processed image or images.

2. A printing method characterized in that it comprises:
one or more steps in which at least a portion of the image data is stored;
one or more steps in which one or more arbitrary regions within at least a portion of the stored image data at which cropped printing should take place is or are specified;
one or more steps in which at least a portion of the stored image data is acquired;
one or more steps in which one or more subsets is or are cut from at least a portion of the acquired image data using one or more cutting frames established based on at least a portion of at least one of the specified region or regions;
one or more steps in which, based on one or more aspect ratios of one or more sheets of printing paper and one or more aspect ratios of one or more images in at least one of the specified region or regions, prescribed processing is carried out on at least a portion of at least one of the image or images in at least one of the specified region or regions so as to cause no margin to be formed at least either horizontally or vertically on at least one of the sheet or sheets of printing paper; and
one or more steps in which at least a portion of at least one of the processed image or images is printed.

3. A printing method according to claim 2 wherein:
at least one of the step or steps in which one or more subsets is or are cut from at least a portion of the image data is such that portion or portions extending beyond one or more edges of at least one of the sheet or sheets of printing paper is or are also taken into consideration in establishing one or more cutting frames larger than at least one of the specified locus or loci, at least a portion of the image data being cut therewith so as to cause no margin to be formed at least horizontally or vertically on at least one of the sheet or sheets of printing paper.

4. A printing method according to claim 3 wherein:
at least one of the step or steps in which prescribed processing is carried out on at least a portion of at least one of the image or images is such that at least a portion of at least one of the image or images in at least one of the specified region or regions is enlarged and/or reduced and/or rotated based on one or more aspect ratios of one or more sheets of printing paper and one or more aspect ratios of one or more images in at least one of the specified region or regions and one or more print layouts.

5. A printing method according to claim 4 wherein:
at least one of the step or steps in which prescribed processing is carried out on at least a portion of at least one of the image or images is such that, in the event that at least a portion of at least one of the image or images in at least one of the specified region or regions is rotated, at least a portion of at least one of the image or images in at least one of the specified region or regions is rotated so as to cause one or more orientations of one or more edges in one or more long directions of at least one of the image or images in at least one of the specified region or regions to match one or more orientations of one or more edges in one or more long directions of one or more print regions established at at least one of the sheet or sheets of printing paper.

6. A printing method according to claim 5 wherein:
at least one of the step or steps in which prescribed processing is carried out on at least a portion of at least one of the image or images is such that, in the event that at least a portion of at least one of the image or images in at least one of the specified region or regions is enlarged and/or reduced, enlargement and/or reduction is carried out such that at least one of the aspect ratio or ratios of at least one of the image or images in at least one of the specified region or regions is preserved.

7. A printing method according to claim 5 wherein:
at least one of the step or steps in which prescribed processing is carried out on at least a portion of at least one of the image or images is such that, in the event that it is determined that it is possible to achieve borderless printing with no margin on any of the four edges and with distortion within one or more preestablished allowed ranges, at least a portion of at least one of the image or images in at least one of the specified region or regions is enlarged and/or reduced so as to be within at least one of the allowed range or ranges.

8. A printing method according to claim 6 further comprising:
one or more report means for reporting to one or more users that one or more margins may be produced horizontally and/or vertically on at least one of the sheet or sheets of printing paper.

9. An image data creation apparatus creating image data for printing at one or more printers, the image data creation apparatus being characterized in that it comprises:
one or more storage means for storing at least a portion of the image data;
one or more region specification means for specifying one or more arbitrary regions within at least a portion of the stored image data at which cropped printing should take place; and
one or more print request means for, based on one or more aspect ratios of one or more sheets of printing paper and one or more aspect ratios of at least one of the specified region or regions, requesting that at least one of the printer or printers carry out printing so as to cause no margin to be formed at least either horizontally or vertically on at least one of the sheet or sheets of printing paper.

10. A printer characterized in that it comprises:
one or more means for acquiring image data;
one or more cutting means for cutting one or more subsets from at least a portion of the acquired image data using one or more cutting frames established based on one or more regions at which cropped printing should take place;
one or more image processing means for, based on one or more aspect ratios of one or more sheets of printing paper and one or more aspect ratios of one or more images in at least one of the region or regions at which cropped printing should take place, carrying out prescribed processing on at least a portion of at least one of the image or images in at least one of the specified region or regions so as to cause no margin to be formed at least either horizontally or vertically on at least one of the sheet or sheets of printing paper; and
one or more printing means for printing at least a portion of at least one of the processed image or images.

11. A printer according to claim 10 further comprising:
one or more report means for reporting to one or more users that one or more margins may be produced horizontally and/or vertically on at least one of the sheet or sheets of printing paper.

12. A printer according to claim 11 further comprising:
one or more region specification means for specifying one or more arbitrary regions within at least a portion of the image data at which cropped printing should take place.

13. A printing method for carrying out borderless printing of one or more subsets of image data on roll paper, the printing method being characterized in that it comprises:
one or more steps in which at least a portion of the image data is stored;
one or more steps in which one or more arbitrary regions within at least a portion of the stored image data at which cropped printing should take place is or are specified;
one or more steps in which at least a portion of the stored image data is acquired;
one or more steps in which one or more subsets is or are cut from at least a portion of the acquired image data using one or more cutting frames established based on at least a portion of at least one of the specified region or regions;
one or more steps in which, based on one or more width dimensions of the roll paper and one or more aspect ratios of one or more images in at least one of the specified region or regions, prescribed processing is carried out on at least a portion of at least one of the image or images in at least one of the specified region or regions so as to cause one edge of at least one of the image or images in at least one of the specified region or regions to more or less match at least one of the width dimension or dimensions of the roll paper; and
one or more steps in which at least a portion of at least one of the processed image or images is printed.
